(19) United States
(12) Patent Application Publication
(10) Pub. No.: US 2005/0157674 A1
(43) Pub. Date: Jul. 21, 2005

(54) Time-scheduled multichannel direct link

(75) Inventor: Menzo Wentink, Utrecht (NL)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: GlobespanVirata Incorporated

(21) Appl. No.: 10/880,325

(22) Filed: Jun. 30, 2004

Related U.S. Application Data
(60) Provisional application No. 60/515,701, filed on Oct. 31, 2003.

(51) Int. Cl. H04Q 7/00

(52) U.S. Cl. 370/328

(57) ABSTRACT

Disclosed herein are exemplary techniques for communicating information in a wireless system using multiple wireless channels. A direct link between two or more wireless devices may be established by performing a direct link setup between two or more wireless devices using an access point. The two or more wireless devices may switch to a parallel channel and use the established direct link to communicate information directly without the access point as an intermediary. Switching the wireless devices between a base channel and one or more parallel channels may be accomplished using one or more predetermined channel schedules.

### CROSS-REFERENCE TO RELATED APPLICATIONS

The present invention claims benefit of U.S. patent application Ser. No. 60/515,701 (Client Reference: GV 297; Attorney Docket No.: 56162.000497) filed Oct. 31, 2003 and entitled “Location Awareness in Wireless Networks,” the entirety of which is incorporated by reference herein.

U.S. patent application Ser. No. ______ (Client Reference: GV 317; Attorney Docket No.: 56162.000517) filed concurrently herewith and entitled “Event-Based MultiChannel Direct Link,” U.S. patent application Ser. No. ______ (Client Reference: GV 318; Attorney Docket No.: 56162.000518) filed concurrently herewith and entitled “Direct Link Relay In a Wireless Network,” U.S. patent application Ser. No. ______ (Client Reference: GV 319; Attorney Docket No.: 56162.000519) filed concurrently herewith and entitled “Link Margin Notification Using Return Frame,” all claiming benefit of U.S. Provisional Application No. 60/515,701 (Client Reference: GV 297; Attorney Docket No.: 56162.000497) filed Oct. 31, 2003, the entireties of which are incorporated by reference herein.

The entirety of U.S. patent application Ser. No. 10/353,391 filed Jan. 29, 2003 and entitled “Direct Link Protocol In Wireless Local Area” is also incorporated by reference herein.

### FIELD OF THE INVENTION

The present invention relates generally to communications between wireless devices and more particularly to utilizing multiple wireless channels to communicate information.

### BACKGROUND OF THE INVENTION

Various wireless standards, such as the Institute of Electrical and Electronics Engineers (EEE) standards 802.11a/b/c/e/g/i (referred to collectively as IEEE 802.11), provide for wireless connectivity between wireless devices, such as, for example, between a wireless station and an access point connected to an infrastructure network. In conventional wireless standards, the communication of information between peer wireless devices typically is routed through the access point. To illustrate, to communicate information between a first wireless device and a second wireless device, the first wireless device wirelessly transmits one or more frames of information to the access point, where the frames designate the second wireless device as their destination. The access point then modifies the headers of the frames and transmits them for reception by the second wireless device.

The process of using the access point as an intermediary has a number of drawbacks. For one, the communication of information is delayed by routing it through the access point. Moreover, the wireless channel used by the wireless devices and access point to communicate information (also referred to as the “base” channel) may be crowded with traffic from other wireless devices similarly seeking to transmit information via the access point. As a result, access contention mechanisms often are implemented, which typically results in additional delay.

Accordingly, an improved technique for communicating information between wireless devices would be advantageous.

### SUMMARY OF THE INVENTION

The present invention mitigates or solves the above-identified limitations in known solutions, as well as other unspecified deficiencies in known solutions. A number of advantages associated with the present invention are readily evident to those skilled in the art, including economy of design and resources, transparent operation, cost savings, etc.

The present invention provides, in a wireless network comprising an access point wirelessly connected to a plurality of wireless devices, in which each of the wireless devices has a wireless direct link with at least one other wireless device, a method which includes scheduling, at each of the wireless devices, a plurality of channel switches for the wireless device during a first interval based at least in part on channel scheduling information for the first interval. At least one channel switch includes a switch to a parallel channel to communicate information via a wireless direct link on the parallel channel for a first portion of the first interval.

A further aspect of the present invention is a method including receiving, at a first wireless device, channel scheduling information for a first interval, tuning the first wireless device to a first channel for a first portion of the first interval, communicating information between the first wireless device and at least a second wireless device via a wireless direct link on the first channel during the first portion of the first interval; and tuning the first wireless device to a second channel for a second portion of the first interval. Also, the timing of the first portion of the first interval and a timing of the second portion of the first interval are based at least in part on the channel scheduling information in a wireless network.

A further aspect of the present invention is a method including determining a channel schedule for each of a plurality of wireless direct links for a first interval, wherein the channel schedule information for a wireless direct link provides for at least one channel switch for wireless devices associated with the wireless direct link during the first interval and where at least one of the channel switches includes a channel switch to a parallel channel to communicate information via the wireless direct link on the parallel channel for a first portion of the first interval and providing channel schedule information to the wireless devices for scheduling one or more channel switches during the first interval in a wireless network.

A further aspect of the present invention is a wireless device including a transceiver and a direct link module operably connected to the transceiver and being adapted to receive channel scheduling information for a first interval;
tune the transceiver to a first channel for a first portion of the first interval, communicate information with at least one other wireless device via a wireless direct link on the first channel during the first portion of the first interval, and tune the transceiver to a second channel for a second portion of the first interval. Also, the timing of the first portion of the first interval and a timing of the second portion of the first interval are based at least in part on the channel scheduling information.

A further aspect of the present invention is an access point wirelessly connected to a plurality of wireless devices, each of the wireless devices has a wireless direct link with at least one other wireless device, the access point a transceiver and a channel scheduling module operably connected to the transceiver and adapted to determine channel schedule information for the wireless direct links for a first interval, wherein the channel schedule information for a wireless direct link provides for at least one channel switch for the wireless devices associated with the wireless direct link during the first interval and where at least one of the channel switches includes a channel switch to a parallel channel to communicate information via the wireless direct link on the parallel channel for a first portion of the first interval, and provide the channel schedule information to the wireless devices for scheduling one or more channel switches during the first interval via the transceiver.

Still further features and advantages of the present invention are identified in the ensuing description, with reference to the drawings identified below.

### BRIEF DESCRIPTION OF THE DRAWINGS

The purpose and advantages of the present invention will be apparent to those of ordinary skill in the art from the following detailed description in conjunction with the appended drawings in which like reference characters are used to indicate like elements, and in which:

FIG. 1 is a schematic diagram illustrating an exemplary wireless system having multiple channels for communicating information between wireless devices is illustrated in accordance with at least one embodiment of the present invention.

FIGS. 2A and 2B are charts illustrating exemplary time-based channel switch processes for the wireless devices of FIG. 1 in accordance with at least one embodiment of the present invention.

FIG. 3 is a schematic diagram illustrating an exemplary access point in greater detail in accordance with at least one embodiment of the present invention.

FIG. 4 is a flow diagram illustrating an exemplary method for scheduling direct links on multiple channels in accordance with at least one embodiment of the present invention.

FIG. 5 is a schematic diagram illustrating an exemplary wireless device in greater detail in accordance with at least one embodiment of the present invention.

FIG. 6 is a flow diagram illustrating an exemplary method for communicating information over multiple channels based on a channel schedule in accordance with at least one embodiment of the present invention.

### DETAILED DESCRIPTION OF THE INVENTION

The following description is intended to convey a thorough understanding of the present invention by providing a number of specific embodiments and details involving the communication of information using multiple wireless channels. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

For ease of illustration, the various techniques of the present invention are discussed below in the context of IEEE 802.11-based wireless networking. However, those skilled in the art, using the teachings provided herein, may advantageously implement the disclosed techniques in other wireless networks. Accordingly, reference to techniques and components specific to IEEE 802.11, such as an 802.11-specific frame format or an series of transmissions specific to 802.11, applies also to the equivalent technique or component in other wireless network standards unless otherwise noted. Moreover, various actions standard to IEEE 802.11 and other wireless standards, such as, for example, the transmission of an ACK frame to acknowledge receipt of a frame, are omitted for ease of discussion.

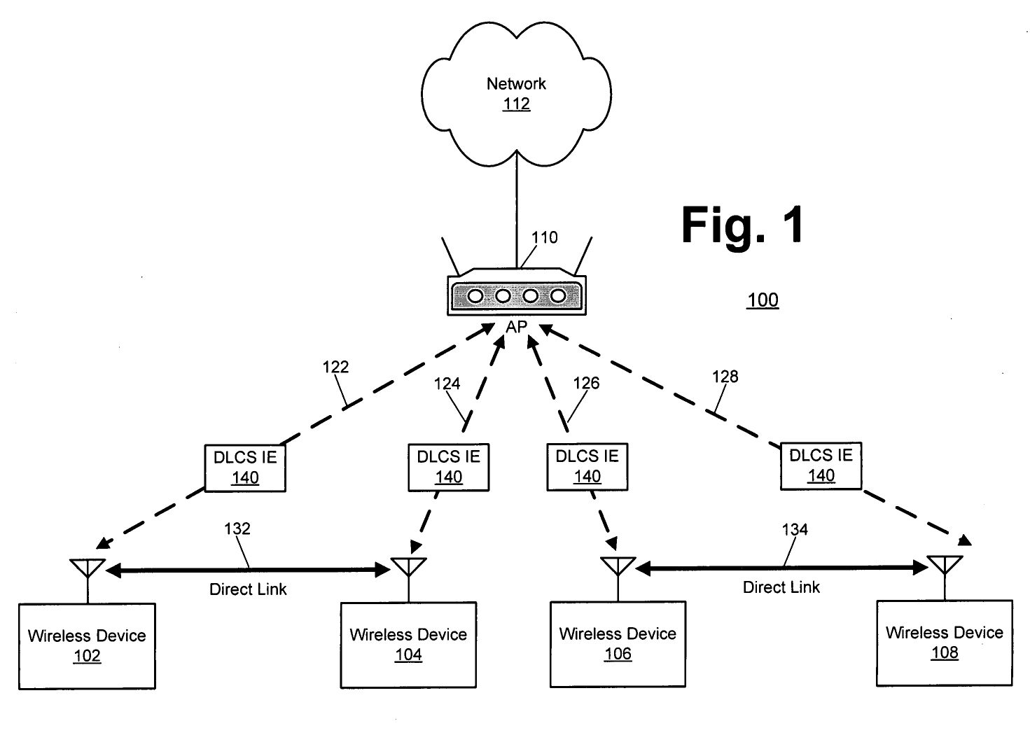

Referring now to FIG. 1, an exemplary wireless system 100 employing one or more exemplary time-based channel switching techniques disclosed herein is illustrated in accordance with at least one embodiment of the present invention. The system 100 incorporates a general wireless network topology described in IEEE 802.11 and other wireless standards wherein a plurality of wireless devices 102-108 are associated with at least one access point 110. The wireless devices 102-108 include devices enabled to communicate wirelessly using one or more protocols. Such protocols may include, for example, the IEEE 802.11 protocols (802.11a/b/e/g/i), etc. Examples of wireless devices may include notebook (or “laptop”) computers, handheld computers, desktop computers, workstations, servers, portable digital assistants (PDAs), cellular phones, audio/visual (A/V) consoles, gaming consoles, televisions or other displays, etc. To illustrate, the system 100 may include, for example, a multimedia system having one or more displays, audio/video components (e.g., a digital video disc (DVD) player or a compact disc (CD) player), sound systems, video game consoles, and the like, where each of these components may be wirelessly connected to a central console acting in the capacity of the access point 110.

The access point 110 may be connected to an infrastructure network 112 or other network, such as, for example, the Internet, a local area network (LAN), a wide area network (WAN), another wireless network, and the like. Thus, wireless devices 102-108 may communicate with one or more networked devices on an infrastructure network 112 via the access point 110. Moreover, the wireless devices 102-108 may communicate with each other via the access point 110 using conventional wireless links 122-128, respectively, or, as discussed in greater detail below, via wireless direct links between two or more of the wireless devices 102-108. For purposes of illustration, it is assumed herein that a direct link 132 is used for direct communications between wireless devices 102 and 104 and a direct link 134 is used for direct communications between wireless devices 106 and 108. Exemplary techniques for establishing and maintaining a wireless direct link are described below and in U.S. Pat. Application No. 60/515,701, 10/353,391 the entirety of which is incorporated by reference herein.

In a conventional wireless network, information is communicated between wireless devices via an access point. A transmitting wireless device transmits the information to the access point on a base channel. The access point then processes the information, such as by changing the headers of one or more frames representing the information, and forwards the information to the receiving wireless device on the base channel. This use of the access point as the intermediary results in a delay in the overall transmission time for the information, as well as crowds the base channel because two transmissions take place, rather than one. Moreover, these transmissions may be further delayed due to congestion on the base channel by other transmitting devices.

Accordingly, the present invention provides techniques for enabling wireless devices to communicate information directly without use of the access point, while still permitting the transfer of information from the access point to the wireless devices, and vice versa. In at least one embodiment, conventional wireless links 122-128 between the access point 110 and the wireless devices 102-108, respectively, may be used to initiate, establish and maintain the wireless direct links 132 and 134. Moreover, in at least one embodiment, the wireless direct links 132 and 134 preferably utilize one or more parallel wireless channels (i.e., separate from the base channel) for at least a portion of their duration to improve their throughput by using one or more less-congested parallel channels. Additionally, in at least one embodiment, the wireless devices 102-108 may be configured to switch back to the base channel or other wireless channel to receive buffered downlink information or peer-to-peer information from the access point 110 or to transmit uplink information or peer-to-peer information to the access point 110, for example.

Because the wireless devices 102-108 may utilize multiple channels to transmit information, a mechanism for coordinating the wireless devices' channel switching may be advantageous. Accordingly, in at least one embodiment, the access point 110 develops time-based channel schedules for the wireless devices 102-108 and provides the channel schedules to the wireless devices 102-108 for implementation. For ease of reference, channel scheduling information is referred to herein as the direct link channel schedule (DLCS) information element (IE) or DLCS IE 140. The DLCS IE 140 may contain the channel schedules for each of the plurality of direct links (direct links 132, 134 in the illustrated example) between the wireless devices 102-108. The channel schedule for a particular direct link may include fields for the identifier (e.g., the association ID or AID) for each wireless device that is participating in the direct link, a channel descriptor that defines the parallel channel (e.g., a center frequency and channel width or a low and high frequency), a begin time indicating when the direct link is to commence on or switch to the parallel channel identified by the channel descriptor, and an end time indicating when the direct link is to return to the base channel or other channel. Alternatively, a begin time and a duration value may be used to describe the time period associated with the switch to the identified channel. Outside of the time period defined by the start time and end time, the wireless devices associated with the direct link preferably switch to the base channel or another predetermined channel by default. Accordingly, the channel schedule information further may include a base channel block field indicating whether the direct link is permitted to continue on the base channel when the associated wireless devices switch to the base channel. To illustrate, the DLCS WE may take the exemplary form of:

[<Channel Schedule 1><Channel Schedule 2> . . . <Channel Schedule n>] for direct links number 1-n. Each channel schedule may take the exemplary form of: [<AID 1><AID 2><Channel Descriptor><Begin Time><End Time><Base Channel Block>].

In one embodiment, the start and end times for a channel schedule are absolute time references. To illustrate, the start and end times may be time indications that reference the wireless stations timing synchronization function (TSF) timer, which may be synchronized to the timer at the access point 110 based on a timestamp included in the beacon frames. The benefit of using absolute time references for the start and end times is that they generally do not need to be changed if a DLCS transmission is postponed. However, they generally need to be recalculated for each beacon interval. In another embodiment, the start and end times are relative time references that are based off of some event. To illustrate, the start and end times could be relative to the end of the transmission of the DLCS IE 140 or relative to the target beacon transmission time (TBTT). The benefit of relative time references for the start and end times generally is that they may remain unchanged for multiple beacon intervals.

In at least one embodiment, the DLCS IE 140 is provided to the wireless devices 102-108 on a substantially periodic basis. For example, IEEE 802.11 generally provides for the transmission of a beacon frame at a regular interval, where the time between the transmissions of the beacon frames is commonly referred to as the beacon interval or beacon interval. The beacon frame conventionally serves the purpose of announcing the existence of the access point 110 to any wireless devices within transmission range. The beacon frame also may contain a traffic indication map (TIM) that is used by a receiving wireless device to determine if the access point 110 has any buffered information for it. Accordingly, in at least one embodiment, the access point 110 may provide the DLCS IE 140 to the wireless devices 102-108 as part of the beacon frame. Alternatively, if the DLCS IE 140 includes a relatively large amount of data, it may be transmitted as one or more separate frames (e.g., as a multicast or broadcast frame) before or after the beacon frame. In this instance, the transmission of the separate frame may occur, for example, a short interframe space (SIFS) period before or after the transmission of the beacon frame. Upon receipt of the beacon frame, the wireless devices 102-108 may determine their respective channel schedule from the DLCS IE 140 and implement it as appropriate for the following beacon interval.

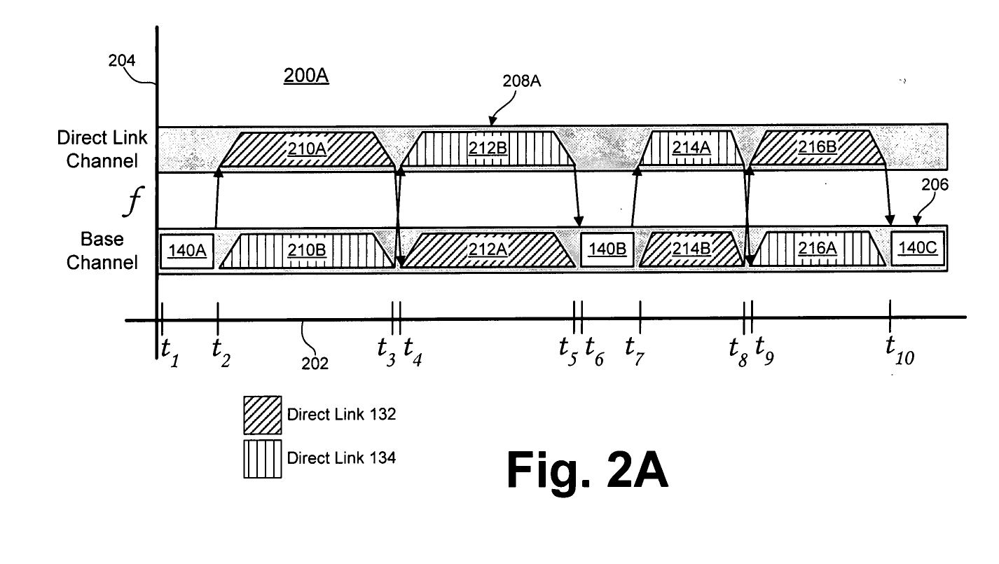

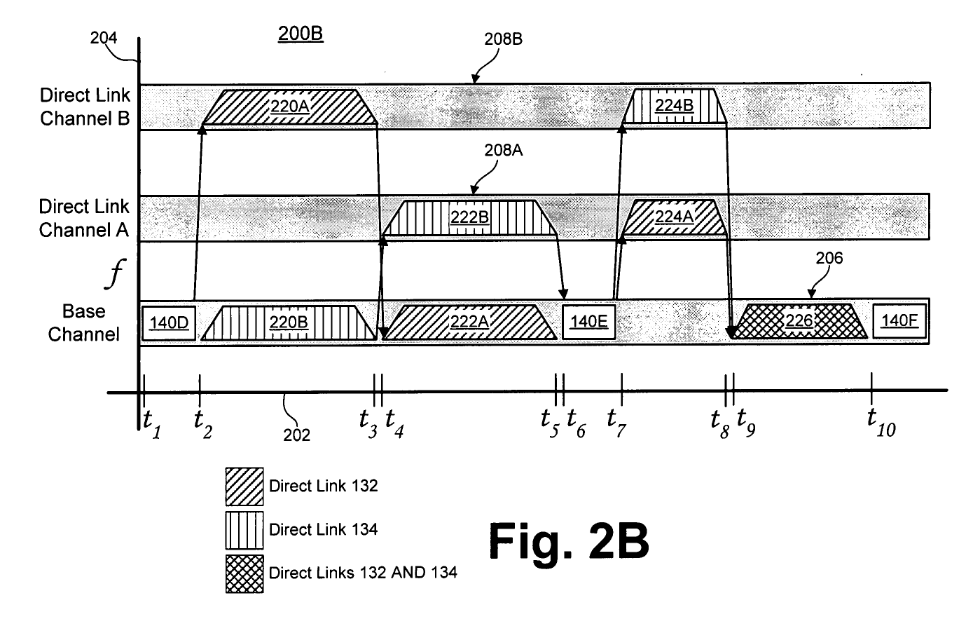

Referring now to FIGS. 2A and 2B, charts 200A and 200B depict exemplary time-based channel switching processes are illustrated in accordance with at least one embodiment of the present invention. The ordinate 202 of the charts 200A and 200B represents time, whereas the abscissa 204 represents at least a portion of the frequency bandwidth in which the system 100 operates. In the illustrated examples, base channel 206 represents the wireless channel used for communications between the access point 110 and the wireless devices 102-108. Parallel channels 208A and 200B represent channels that may be used to communicate information directly between the wireless devices 102-108 via wireless direct links.

FIG. 2A illustrates an exemplary implementation wherein the direct links 132 and 134 switch from the base channel 206 to the parallel channel 208A based on a channel schedule information provided for each of a series of beacon intervals or for other substantially periodic intervals. To illustrate, at time t₁, the access point 110 may transmit a beacon frame having a DLCS IE 104A to each of the wireless devices 102-108, where wireless devices 102 and 104 have established a wireless direct link 132 and wireless devices 106 and 108 have established a wireless direct link 134. In the illustrated example, the DLCS IE 104A provides channel schedule information for the direct link 132 wherein the wireless devices 102 and 104 are scheduled to conduct the direct link 132 on the parallel channel 208A for a time period defined by start time t₂ and end time t₃ (as represented by transmission period 210A). For this same time period, the channel schedule provides for the wireless devices 106 and 108 to conduct the direct link 134 on the base channel 206 (as represented by transmission period 210B). While on the base channel 206, the wireless devices 106 and 108 may receive buffered downlink information from the access point 110, provide uplink information to the access point 110, and/or continue to communicate information directly with each other via the direct link 134 on the base channel. Note, however, that the access point 110 may direct the wireless devices 106 and 108 from conducting the direct link 134 on the base channel for transmission period 210A by, for example, setting a bit in the base channel block field of the corresponding channel schedule in the DLCS IE 140A.

The channel schedule information further may specify that the direct link 132 be switched to the base channel 206 and the direct link 134 be switched to the parallel channel 208A starting at time t₄ and ending at time t₅ (as represented by transmission periods 212A and 212B, respectively). The switch from the parallel channel to the base channel may be explicitly defined by including a start time for the base channel that corresponds to the end time for the direct link's use of the parallel channel 208A, or the switch may be implicit in that start and end times are provided only for the direct link's use of the parallel channel 208A, where all other times the direct link is switched back to the base channel 206. Once switched back to the base channel 206 for transmission period 212A, the wireless devices 102 and 104 may receive downlink information buffered at the access point 110, provide uplink information to the access point 110 and/or communicate peer-to-peer information via the direct link 132 or via the access point 110 on the base channel 206.

At time t₆, which represents the end of the previous beacon interval and the start of the next beacon interval, the wireless devices 102-108 remain at, or switch to, the base channel 206 to receive a beacon frame including the next DLCS IE 104B provided by the access point 110. The DLCS IE 104B provides the channel schedules for the upcoming beacon interval.

Because of the possibility that one or more of the wireless devices 102-108 will not receive the beacon frame having a DLCS IE, in at least one embodiment, the channel schedule remains consistent for a plurality of beacon intervals. Thus, should a wireless device fail to receive the DLCS IE for a beacon interval, the wireless device may assume that the channel schedule for the previous beacon interval is still in effect for the next beacon interval. However, for illustrative purposes, the channel schedules provided by the DLCS IE 104A for the beacon interval of time t₁ to time t₆ are different from the channel schedules represented by the DLCS IE 104B for the beacon interval of time t₆ to time t₁₀.

As with the previous beacon interval, the wireless devices 102-108 implement the channel schedules provided in the DLCS IE 104B. In the illustrated example, the channel schedules provide that the direct link 134 is scheduled to switch to the parallel channel 208A for the time period between time t₇ and time t₈ (represented by transmission period 214A) and switch back to the base channel 206A for the time period between time t₉ and time t₁₀ (represented by transmission period 216A). Conversely, the illustrated channel schedules of DLCS EI 104B provide that the direct link 132 remain on the base channel 206 between time t₇ and time t₈ (represented by transmission period 214B) and switch to the parallel channel 208B for the time period between time t₉ and time t₁₀ (represented by transmission period 216B). During transmission period 214B, the wireless devices 102 and 104 may receive downlink information and provide uplink and peer-to-peer information via the base channel 206 as described above. Similarly, the wireless devices 106 and 108 may communicate information via the base channel 206 during transmission period 216A. During transmission periods 214A and 216B, information may be communicated via direct links 132 and 134, respectively, via the parallel channel 208A. At time t₁₀, the wireless devices 102-108 switch to, or remain on, the base channel 206 to receive the next beacon frame, where the beacon frame includes the DLCS IE 140C that defines the channel schedules for the next beacon interval.

FIG. 2B illustrates an exemplary implementation wherein the direct links 132, 134 may utilize multiple parallel channels (e.g., channels 208A and 208B) subject to the channel scheduling provided by the access point 110. The use of multiple parallel channels may be advantageous when, for example, the direct links 132 and 134 carry considerable traffic and may interfere with each other if on the same channel or if one or more of the parallel channels are used by other nearby wireless devices and therefore do not have the entire bandwidth available.

In the illustrated example, the channel schedules defined by the DLCS IE 140D received at time t₁ provide that direct link 132 is scheduled to switch to parallel channel 208B and direct link 132 is scheduled to remain on the base channel 206 between times t₂ and t₃, as represented by transmission periods 220A and 220B, respectively. For the time period between times t₄ and t₅, the direct link 132 is switched to the base channel 206 (as represented by transmission portion 222A) and the direct link 134 is switched to the parallel channel 206A (as represented by transmission portion 222B).

At time t₆, the next beacon frame is transmitted having the DLCS IE 104E for the upcoming beacon interval. In this example, the DLCS IE 104E includes channel scheduling information directing the direct link 132 to switch to the parallel channel 208A (represented by transmission period 224A) and the direct link 134 to switch to the parallel channel 208B (represented by transmission period 224B) for the time period between times t7 and t8. Thus, because both direct links 132 and 134 are on parallel channels for the same portion of the beacon interval, the channel schedules may direct both direct links 132 and 134 to switch to the base channel 206 at time t₉ so that uplink, downlink and peer-to-peer information may be communicated between the access point 110 and the wireless devices 102-108 on the base channel 206, as represented by transmission period 226. In this instance, wireless devices 102-108 may continue to utilize the direct links 132 and 134 on the base channel 206, or the direct links 132 and 134 may temporarily terminate while during the transmission period 226 to reduce traffic on the base channel 206. Alternatively, the remaining portion of the beacon interval could be divided between the direct links 132 and 134, where the direct link 132 is switched to the base channel 206 for a first portion of the remainder of the beacon interval and the direct link 134 is switched to the base channel 206 for a second portion of the remainder of the beacon interval. At time t₁₀ the wireless devices 102-108 may receive the next beacon frame having the DLCS IE 104F that outlines the channel schedules for the next beacon interval.

Although charts 200A and 200B illustrate various embodiments wherein channel schedules are implemented for two wireless direct links, the same techniques disclosed herein may be applied to schedule the utilization of multiple channels for more than two direct links without departing from the spirit or the scope of the present invention. To illustrate, the exemplary techniques of the present invention may be used to schedule channel switches for n direct links, where the wireless devices associated with each of the n direct links are scheduled to spend a portion of a particular interval on one or more channels and further may be scheduled to spend another portion of the interval on the base channel in order to communicate information with the access point 110. Moreover, although charts 200A and 200B illustrate exemplary embodiments where the wireless devices 102-108 are scheduled only for one time period on a base channel and one time period on a parallel channel per beacon interval, in other embodiments, multiple switches to and from the base channel and/to to and from multiple parallel channels may be scheduled for some or all of the wireless devices 102-108.

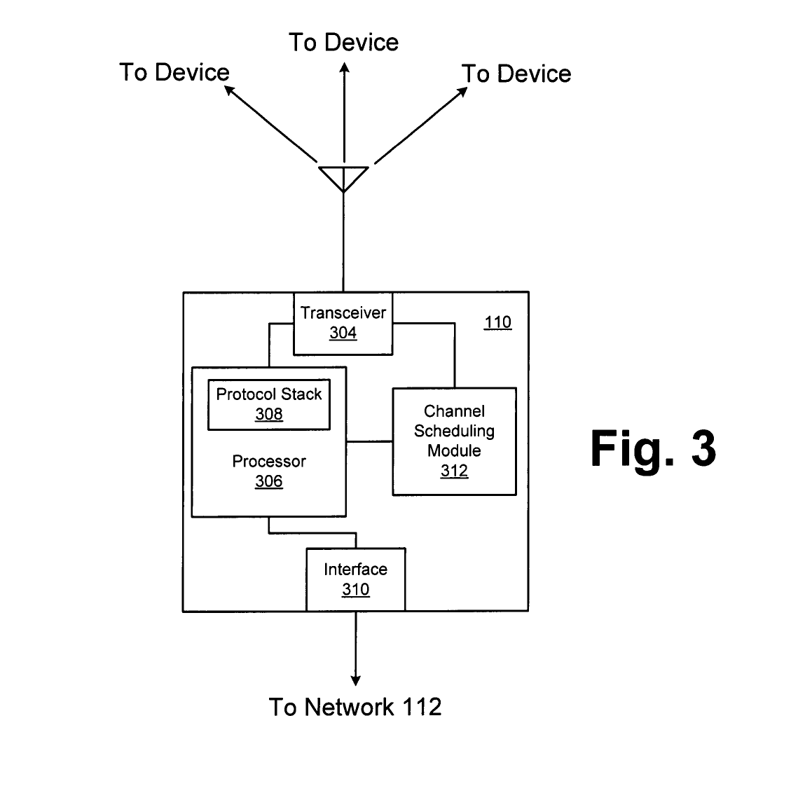

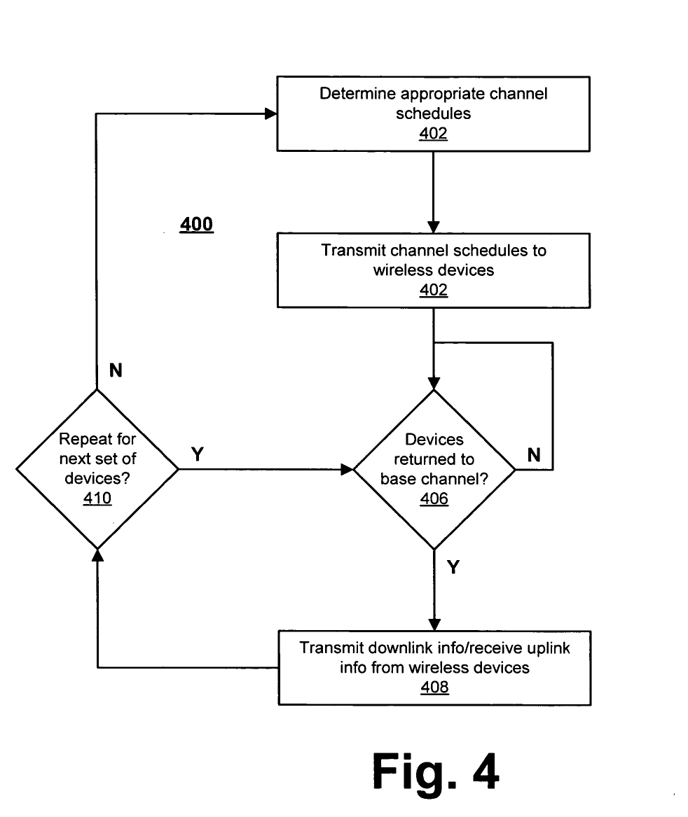

Referring now to FIGS. 3 and 4, an exemplary configuration for the access point 110, as well as an exemplary method 400 of its operation are illustrated in accordance with at least one embodiment of the present invention. Although certain actions are attributed to the access point 110 for ease of reference, those skilled in the art will appreciate that some or all of these actions may be performed by one or more of the wireless devices 102-108.

In the illustrated example of FIG. 3, the access point 110 includes at least a transceiver 304 for transmitting and/or receiving signals representing information, one or more processors 306 and protocol stacks 308 for processing and otherwise preparing information for transmission via the transceiver 304, as well as for processing information received via the transceiver 304. The access point 110 further may include an interface 310 for interfacing with one or more networks 112 (FIG. 1). The access point 110 further includes a channel scheduling module 312 for creating channel schedules for one or more direct links between the wireless devices 102-108, supplying channel schedule information to the wireless devices 102-108, and other various actions described in detail herein. The channel scheduling module 312 may be implemented as software, hardware, firmware, or a combination thereof. To illustrate, the channel scheduling module 312 may be implemented as a software component of the protocol stack 308, as a separate software program or module executed by the processor 306, or as a software or hardware component implemented as part of the transceiver 304. For example, the channel scheduling module 312 may be implemented at least in part as executable instructions adapted to manipulate the processor 306 and/or other processors to perform one or more of its associated functions described herein.

The exemplary method 400 for scheduling channel switches initiates at step 402 wherein the channel scheduling module 312 develops channel schedules for one or more direct links for an upcoming beacon interval. Any of a variety of considerations may be taken into account when developing the channel schedules. These considerations may include, but are not limited to, the estimated traffic volume on the direct links, the throughput of the parallel channels, the traffic already on the parallel channels, the frequency range that the wireless devices 102-108 are capable of operating on, and the like. From these considerations, channel schedules that maximize throughput and/or that minimize power consumption preferably are developed.

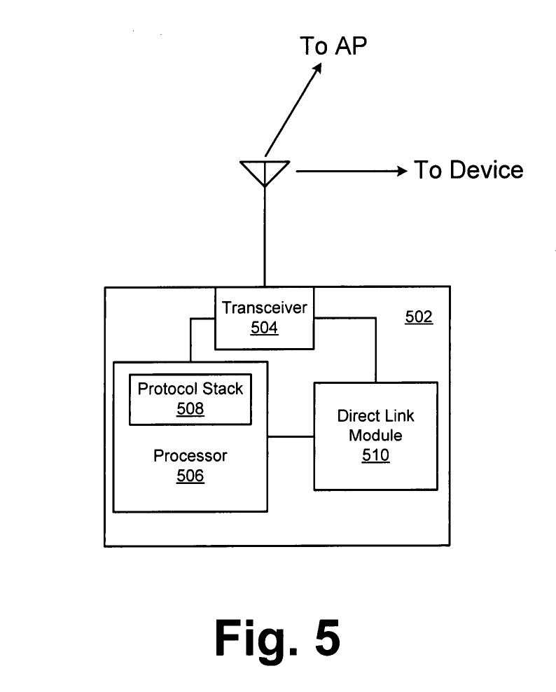

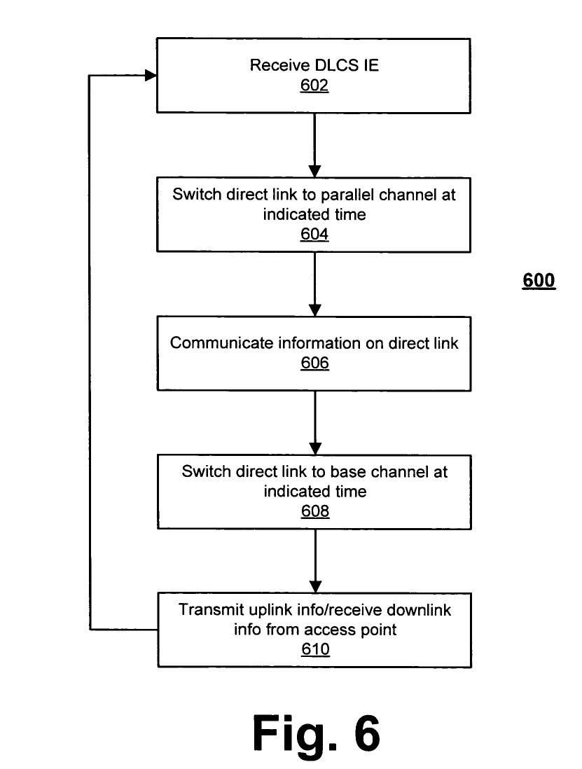

At step 404, the channel scheduling module 312 provides information representative of the channel schedules to the processor 306, protocol stack 308 and transceiver 304 for transmission to the wireless devices 102-108 via, for example, a base channel conventionally used to communicate with the wireless devices 102-108. As noted above, in at least one embodiment, the channel schedules are represented by information included as a DLCS IE in a beacon frame that is multicast or broadcast to the wireless devices 102-108. Upon receipt of the channel schedule information, the wireless devices 102-108 prepare to implement the channel schedules as described below with reference to FIGS. 5 and 6.

When one or more wireless devices switch to the base channel (e.g., by tuning their respective transceivers to the base channel) at step 406, uplink, downlink and peer-to-peer information may be transmitted between the one or more wireless devices and the access point 110 using the base channel at step 408. When the one or more wireless devices switch back to a parallel channel (e.g., by tuning their respective transceivers to the parallel channel), the access point 110 may cease attempts to communicate information with these wireless devices and may buffer downlink information for them until they return again to the base channel. The process of communicating uplink, downlink, and peer-to-peer information may be repeated at step 410 for the next set of wireless devices that switch to the base channel during the beacon interval.

Referring now to FIGS. 5 and 6, an exemplary configuration for the wireless devices 102-108 (illustrated as wireless device 502), as well as an exemplary method 600 of its operation are illustrated in accordance with at least one embodiment of the present invention. In the illustrated example, the wireless device 502 includes at least a transceiver 504 for transmitting and/or receiving signals representing information, one or more processors 506 and protocol stacks 508 for processing and otherwise preparing information for transmission via the transceiver 504, as well as for processing information received via the transceiver 504. The wireless device 502 further includes a direct link module 510 for establishing, maintaining and utilizing one or more direct links with other wireless devices, as well as implementing one or more channel schedules provided by the access point 110 and other various actions described in detail herein. The direct link module 510 may be implemented as software, hardware, firmware, or a combination thereof. To illustrate, the direct link module may be implemented as a software component of the protocol stack 508, as a separate software program or module executed by the processor 506, or as a software or hardware component implemented as part of the transceiver 504. For example, the direct link module 510 may be implemented in whole or in part as executable instructions adapted to manipulate the processor 506 and/or other processors to perform one or more of its associated functions described herein.

The exemplary method 600 for implementing channel schedules initiates at step 602 wherein channel scheduling information is received at the wireless device 502 from the access point 110. As noted above, the channel scheduling information may be represented as a DLCS IE included as part of a beacon frame or similar transmission from the access point 110. In at least one embodiment, the relevant information represented by the channel scheduling information is parsed into one or more scheduling tables maintained by the direct link module 510 and used to determine when a channel switch is scheduled to occur.

At step 604, the wireless device 502 switches its direct link to a parallel channel by tuning the transceiver 504 to the parallel channel at the start time indicated by the corresponding channel schedule. As noted above, the start and end times may be relative to some event (such as the transmission of the beacon frame) or absolute (i.e., a specified time corresponding to a synchronized timer or clock at the wireless device 502). Accordingly, the direct link module 510 may set or poll a timer to determine when the indicated set time has occurred and tune the transceiver 504 at that time.

After switching to the parallel channel, the wireless device 502 communicates information with the other wireless device over a corresponding direct link at step 606. When the end time indicated in the corresponding channel schedule lapses, the direct link module 510 switches the wireless device 502 back to the base channel by tuning the transceiver 504 to the base channel at step 608. Once back on the base channel, the wireless device 502 may communicate uplink, downlink and/or peer-to-peer information with the access point 110 via the base channel at step 610. Steps 604, 606 and/or 608 may be repeated any number of times based on the channel schedules associated with the beacon interval. Moreover, the steps 602-610 may be repeated for the next beacon interval using the same channel schedules or using updated channel schedules received from, for example, the access point 110.

Other embodiments, uses, and advantages of the invention will be apparent to those skilled in the art from consideration of the specification and practice of the invention disclosed herein. The specification and drawings should be considered exemplary only, and the scope of the invention is accordingly intended to be limited only by the following claims and equivalents thereof.

1. In a wireless network comprising an access point wirelessly connected to a plurality of wireless devices, each of the wireless devices having a wireless direct link with at least one other wireless device, the method comprising:
scheduling, at each of the wireless devices, a plurality of channel switches for the wireless device during a first interval based at least in part on channel scheduling information for the first interval;
wherein at least one channel switch includes a switch to a parallel channel to communicate information via a wireless direct link on the parallel channel for a first portion of the first interval.

2. The method as in claim 1, wherein at least one channel switch includes a channel switch to a base channel to communicate information with the access point on the base channel for a second portion of the first interval.

3. The method as in claim 2, wherein the first portion occurs prior to the second portion.

4. The method as in claim 2, wherein the second portion occurs prior to the first portion.

5. The method as in claim 2, wherein the channel switch to the parallel channel includes a channel switch from the base channel.

6. The method as in claim 1, further comprising:
providing, from the access point, the channel scheduling information to the wireless devices.

7. The method as in claim 6, wherein the first interval is a beacon interval and providing the channel scheduling information comprises:
providing a beacon frame having the channel scheduling information at a beginning of the beacon interval.

8. The method as in claim 1, wherein the channel scheduling information for the first interval includes a start time and a stop time for the first portion of the first interval.

9. The method as in claim 1, further comprising:
scheduling, at each of the wireless devices, a plurality of channel switches for the wireless device during a second interval based at least in part on channel scheduling information for the second interval;
wherein at least one channel switch includes a switch to a parallel channel to communicate information via a wireless direct link on the parallel channel for a first portion of the second interval.

10. In a wireless network comprising an access point wirelessly connected to at least two wireless devices, a method comprising:
receiving, at a first wireless device, channel scheduling information for a first interval;
tuning the first wireless device to a first channel for a first portion of the first interval;
communicating information between the first wireless device and at least a second wireless device via a wireless direct link on the first channel during the first portion of the first interval; and
tuning the first wireless device to a second channel for a second portion of the first interval;
wherein a timing of the first portion of the first interval and a timing of the second portion of the first interval are based at least in part on the channel scheduling information.

11. The method as in claim 10, further comprising:
communicating information between the first wireless device and the access point via the second channel during the second portion of the first interval.

12. The method as in claim 10, wherein receiving the channel scheduling information includes receiving a beacon frame including the channel scheduling information from the access point at a start of a beacon interval.

13. The method as in claim 10, wherein the channel scheduling information includes a start time and a stop time for the first portion of the first interval.

14. The method as in claim 13, wherein the second portion of the first interval includes a remaining portion of the first interval.

15. The method as in claim 10, further comprising:
tuning the first wireless device to a third channel for a third portion of the first interval; and
communicating information with at least the second wireless device via a second wireless direct link on the third channel during the third portion of the first interval;
wherein a timing of the third portion of the first interval is based at least in part on the channel scheduling information.

16. The method as in claim 10, further comprising:
tuning the first wireless device to a third channel for a first portion of a second interval;
communicating information between the first wireless device and at least the second wireless device via a wireless direct link on the third channel during the first portion of the second interval;
tuning the first wireless device to the second channel for a second portion of the second interval; and
communicating information between the first wireless device and the access point via the second channel during the second portion of the second interval.

17. The method as in claim 16, wherein a timing of the first portion of the second interval and a timing of the second portion of the second interval are based at least in part on the channel scheduling information for the first interval.

18. The method as in claim 16, further comprising:
receiving, at the first wireless device, channel scheduling information for the second interval;
wherein a timing of the first portion of the second interval and a timing of the second portion of the second interval are based at least in part on the channel scheduling information for the second interval.

19. The method as in claim 10, further comprising:
receiving, at a third wireless device, channel scheduling information for the first interval;
tuning the third wireless device to the second channel for the first portion of the first interval;
communicating information between the third wireless device and the access point on the second channel during the first portion of the first interval;
tuning the third wireless device to the first channel for the second portion of the first interval; and
communicating information between the third wireless device and at least a fourth wireless device via a second wireless direct link on the first channel during the second portion of the first interval.

20. The method as in claim 10, further comprising:
receiving, at a third wireless device, channel scheduling information for the first interval;
tuning the third wireless device to the second channel for the first portion of the first interval;
communicating information between the third wireless device and the access point on the second channel during the first portion of the first interval;
tuning the third wireless device to a third channel for the second portion of the first interval; and
communicating information between the third wireless device and at least a fourth wireless device via a second wireless direct link on the third channel during the second portion of the first interval.

21. The method as in claim 10, wherein the first portion occurs before the second portion.

22. The method as in claim 10, wherein the second portion occurs before the first portion.

23. In a wireless network comprising an access point wirelessly connected to a plurality of wireless devices, wherein each of the wireless devices has a wireless direct link with at least one other wireless device, the method comprising:
determining a channel schedule for each of the wireless direct links for a first interval, wherein the channel schedule information for a wireless direct link provides for at least one channel switch for the wireless devices associated with the wireless direct link during the first interval and where at least one of the channel switches includes a channel switch to a parallel channel to communicate information via the wireless direct link on the parallel channel for a first portion of the first interval; and
providing channel schedule information to the wireless devices for scheduling one or more channel switches during the first interval.

24. The method as in claim 23, wherein at least one of the channel switches includes a channel switch to a base channel to communicate information with the access point on a base channel for a second portion of the first interval.

25. The method as in claim 24, wherein the first portion occurs prior to the second portion.

26. The method as in claim 24, wherein the second portion occurs prior to the first portion.

27. The method as in claim 23, wherein the first interval is a beacon interval and providing the channel scheduling information comprises:
providing a beacon frame having the channel scheduling information from the access point at a beginning of the beacon interval.

28. The method as in claim 23, wherein the channel scheduling information for the first interval includes a start time and a stop time for the first portion of the first interval.

29. In a wireless network, a wireless device comprising:
a transceiver; and
a direct link module operably connected to the transceiver and being adapted to:
receive channel scheduling information for a first interval;
tune the transceiver to a first channel for a first portion of the first interval;
communicate information with at least one other wireless device via a wireless direct link on the first channel during the first portion of the first interval; and
tune the transceiver to a second channel for a second portion of the first interval;
wherein a timing of the first portion of the first interval and a timing of the second portion of the first interval are based at least in part on the channel scheduling information.

30. The wireless device as in claim 29, wherein the direct link module is further adapted to communicate information with an access point via the second channel during the second portion of the first interval.

31. The wireless device as in claim 29, wherein the channel scheduling information is received as part of a beacon frame transmitted from the access point at a start of a beacon interval.

32. The wireless device as in claim 29, wherein the channel scheduling information includes a start time and a stop time for the first portion of the first interval.

33. The wireless device as in claim 32, wherein the second portion of the first interval includes a remaining portion of the first interval.

34. The wireless device as in claim 29, wherein the direct link module is further adapted to:
tune the transceiver to a third channel for a third portion of the first interval; and
communicate information with at least one other wireless device via a second wireless direct link on the third channel during the third portion of the first interval;
wherein a timing of the third portion of the first interval is based at least in part on the channel scheduling information.

35. The wireless device as in claim 29, wherein the direct link module is further adapted to:
tune the transceiver to a third channel for a first portion of a second interval;
communicate information with at least one other wireless device via a wireless direct link on the third channel during the first portion of the second interval;
tuning the first wireless device to the second channel for a second portion of the second interval; and
communicating information with the access point via the second channel during the second portion of the second interval.

36. The wireless device as in claim 29, wherein the first portion occurs before the second portion.

37. The wireless device as in claim 29, wherein the second portion occurs before the first portion.

38. The wireless device as in claim 29, further comprising at least one processor operably connected to the transceiver, and wherein the direct link module comprises executable instructions adapted to manipulate the at least one processor to:
receive the channel scheduling information for the first interval;
tune the transceiver to the first channel for the first portion of the first interval;
communicate information with at least one other wireless device via the wireless direct link on the first channel during the first portion of the first interval;
tune the transceiver to the second channel for the second portion of the first interval.

39. The wireless device as in claim 38, wherein the executable instructions are further adapted to manipulate the one or more processors to communicate information with the access point via the second channel during the second portion of the first interval.

40. An access point wirelessly connected to a plurality of wireless devices, wherein each of the wireless devices has a wireless direct link with at least one other wireless device, the access point comprising:
a transceiver; and
a channel scheduling module operably connected to the transceiver and adapted to:
determine channel schedule information for the wireless direct links for a first interval, wherein the channel schedule information for a wireless direct link provides for at least one channel switch for the wireless devices associated with the wireless direct link during the first interval and where at least one of the channel switches includes a channel switch to a parallel channel to communicate information via the wireless direct link on the parallel channel for a first portion of the first interval; and
provide the channel schedule information to the wireless devices for scheduling one or more channel switches during the first interval via the transceiver.

41. The access point as in claim 40, wherein at least one of the channel switches includes a channel switch to a base channel to communicate information with the access point on the base channel for a second portion of the first interval.

42. The access point as in claim 40, wherein the first interval is a beacon interval and the channel scheduling module is adapted to provide the channel scheduling information by providing a beacon frame having the channel scheduling information at a beginning of the beacon interval.

43. The access point as in claim 40, wherein the channel scheduling information for the first interval includes a start time and a stop time for the first portion of the first interval.

44. The access point as in claim 40, further comprising at least one processor operably connected to the transceiver, and wherein the channel scheduling module includes executable instructions adapted to manipulate the at least one processor to:
determine the channel schedule information for the wireless direct links for the first interval; and
provide the channel schedule information to the wireless devices for scheduling channel switches during the first interval via the transceiver.
